(19) United States
(12) Patent Application Publication
(10) Pub. No.: US 2021/0390490 A1
(43) Pub. Date: Dec. 16, 2021

(54) SYSTEMS, DEVICES, AND METHODS FOR QUALITY CONTROL AND INSPECTION OF PARTS AND ASSEMBLIES

(71) Applicant: INTERAPTIX INC., Toronto (CA)

(72) Inventors: Dae Hyun Lee, Etobicoke (CA); Bardia Bina, Oakville (CA); Behzad Abghari, Toronto (CA)

(21) Appl. No.: 17/345,764

(22) Filed: Jun. 11, 2021

Related U.S. Application Data
(60) Provisional application No. 63/037,883, filed on Jun. 11, 2020.

(51) Int. Cl. G06Q 10/06

(52) U.S. Cl. CPC G06Q 10/06395

(57) ABSTRACT

An example method of quality control, assessment, and inspection of parts and assemblies includes: receiving a component image data set comprising data representing at least an image of a portion of a component of a manufactured assembly; processing the received component image data set to interpret at least one characteristic of the component; routing a characteristic review data set comprising data representing the one or more interpreted characteristics; receiving an interpreted characteristic confirmation data set comprising signals representing a confirmation that one or more characterizations associated with the one or more interpreted characteristics is correct; and storing a confirmed component characteristic data set comprising at least data representing an identity of the component and data representing the confirmed characteristic.

### CROSS REFERENCE TO RELATED APPLICATIONS

This application claims priority to U.S. Provisional Application No. 63/037883, filed Jun. 11, 2020 the entirety of which is incorporated herein by reference,

### FIELD OF THE INVENTION

The present disclosure relates to systems, devices, and methods for improved electronic data capture, collection, processing, and storage, with particular application to the implementation of efficient and effective quality control and inspection processes pertaining to the assembly, assessment, use, and maintenance of mechanical, electrical, and other systems.

### BACKGROUND OF THE INVENTION

In many manufacturing fields, including for example assembly of aerospace and other types of transportation system components, electronics, and medical systems, it can be important to support extended system life and performance standards. In doing so, it can be important to correctly and efficiently assess or track the proper assembly and performance of individual parts or subassemblies, so that design, manufacturing, and use defects, as well as normal wear and tear, can all be monitored and systematically reduced or eliminated.

To that end, it can be important to track individual part and component make and/or model identifiers, as well as individual identifiers (colloquially, “part” and “serial” “numbers,” respectively), optionally in association with images of other characteristics of various parts, assemblies, or other components. (Collectively or individually, in this disclosure parts, subassemblies, and assemblies are optionally referred to as “components”). Using known tools and methods, tracking such identifiers or other characteristics individually, and as components of larger assemblies, can be time consuming and prone to error.

There is a need for improved systems, devices, processes, and programs for capturing, interpreting or otherwise assessing, reviewing, and identifying part type and component numbers and other component characteristics, and particularly for improved efficiency of such systems, devices, processes, and programs.

### SUMMARY OF THE INVENTION

In various aspects, and as further explained below, the present disclosure provides systems, devices, methods, and persistently-stored, machine-interpretable programming and/or other data products for facilitating quality control, inspection, and assessment of parts and assemblies.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1A and 1B are schematic block diagrams showing embodiments of a system for facilitating quality control, assessment, and inspection of parts and assemblies in accordance with various aspects and embodiments of the invention.

FIGS. 2a-2d are schematic diagrams showing various aspects of components and operation of devices used for capturing images of component characteristics and assembly information in accordance with various aspects and embodiments of the invention.

FIG. 3 is a schematic diagram showing various aspects of components and operation of quality assurance control and review devices used for reviewing captured and interpreted data in accordance with various aspects and embodiments of the invention.

FIG. 4 is a schematic diagram showing various aspects of a quality assurance data set generated and stored by systems and devices in accordance with various aspects and embodiments of the invention.

FIG. 5 is a schematic diagram showing an embodiment of aspects of a method for capturing, assessing, editing, and otherwise processing quality assurance information in accordance with various aspects and embodiments of the invention.

### DESCRIPTION OF EMBODIMENTS

In various aspects and embodiments, the invention provides systems, methods, devices, and computer programming products for facilitating quality control, assessment, and inspection (also “quality assurance” or QA) procedures with respect to parts and assemblies. Among other advantages, the invention offers significant advances in the accuracy and ease of tracking individual parts and components of assemblies and subassemblies, as well as features or characteristics of such components, with related increases in efficiency, reliability, and cost-effectiveness. Moreover, quality control and other forms of inspection can be carried by accessing and interpretation of digital twins, such as 2-d or 3-d images or models, rather than actual physical interaction with components. This can not only make such work more efficient, but also enables quality control and other types of inspection to be conducted remotely, at any desired locations or combination of locations. The use of such digital twins can include their use as forms of reference or documentation of components, assemblies, and/or other products as built, as shipped, or at other points in their life or use cycles.

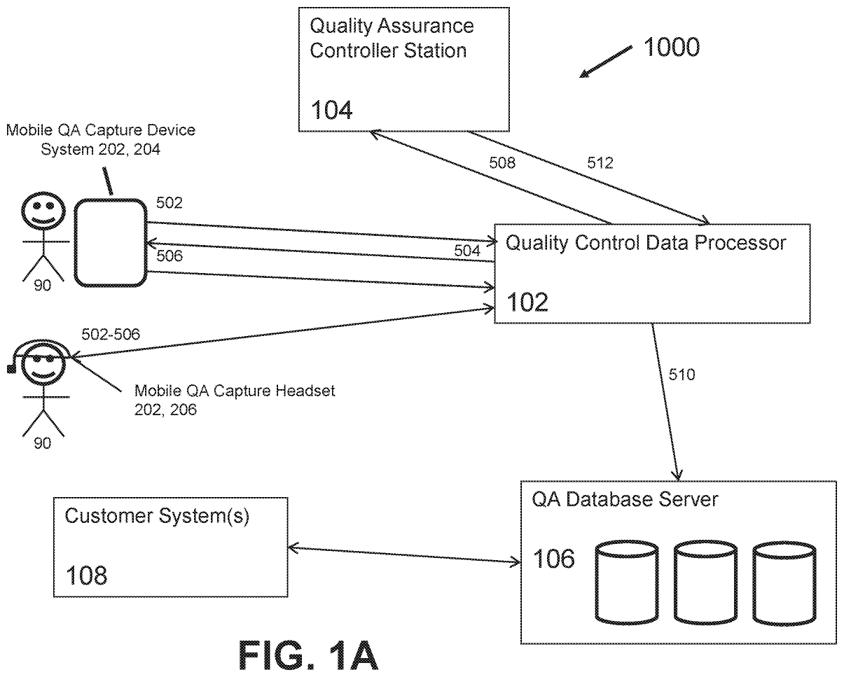

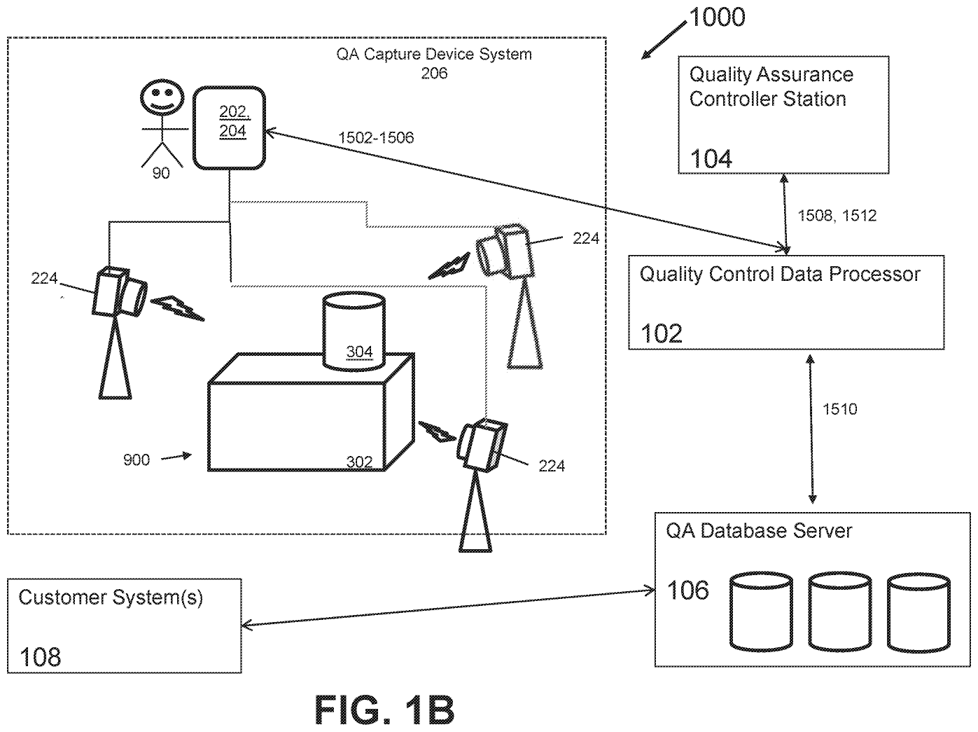

FIGS. 1A and 1B are schematic block diagrams showing embodiments of a system or architecture 1000 suitable for use in implementing various aspects and embodiments of a tool for improved quality control, maintenance, and inspection for parts and components of a very wide variety of systems. In the embodiment shown in FIG. 1A, a system 1000 comprises one or any other desired number(s) of quality control data processor(s) 102, QA controller station(s) 104, data storage facility(ies) 106, customer system(s) 108, and mobile quality-assurance or attribute (e.g., identifier) capture device(s) 202.

Each of components 102, 104, 106, 108, 202 can be of any type(s) or form(s) suitable for use in implementing the purposes disclosed or suggested herein. As will be readily appreciated by those skilled in the relevant arts, for example, such components may be implemented using any electronic signal/data processors, such as smart phones and other mobile network communications systems, desktop or server-class networked stationary platforms, etc., suitable for configuration to accomplish the purposes disclosed herein; and they may be implemented in any numbers desired. They may each or all be communicatively linked using any suitable wireline or wireless communications systems, including any or all of any suitable radio, cellular telephone, public switched telephone, and local and/or wide-area network technologies and protocols 150, including for example the internet and IP protocols such as hypertext transfer protocol (HTTP).

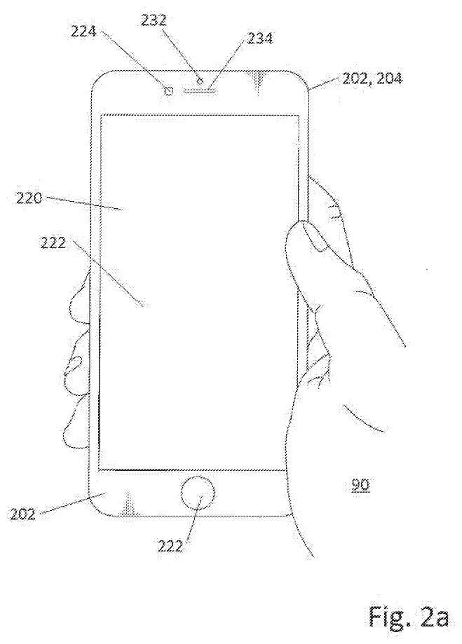

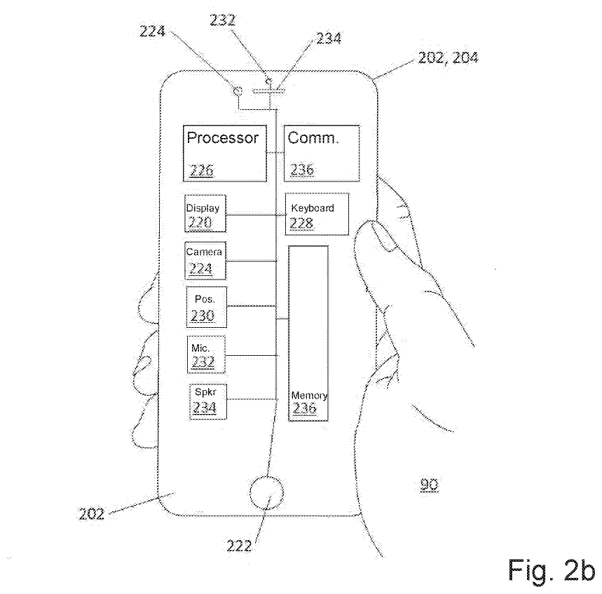

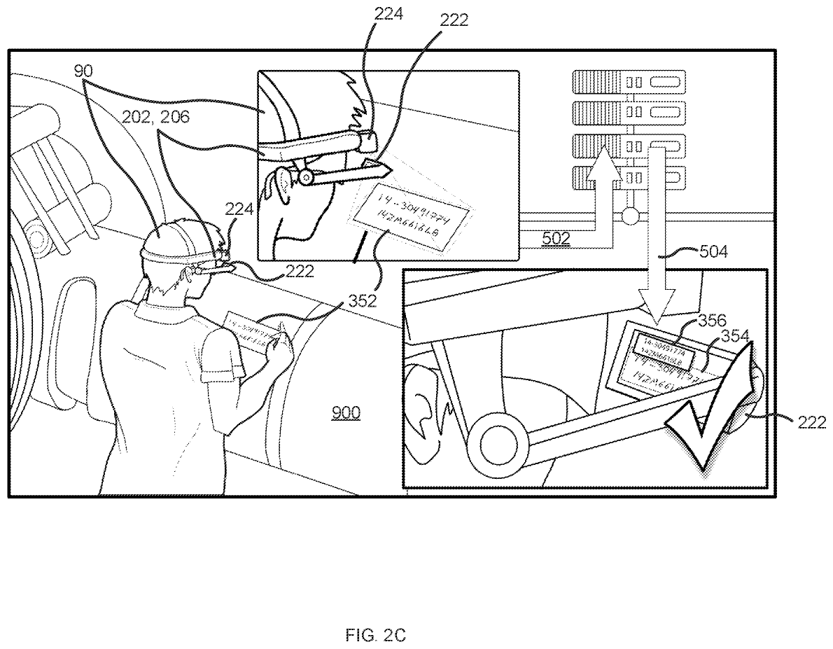

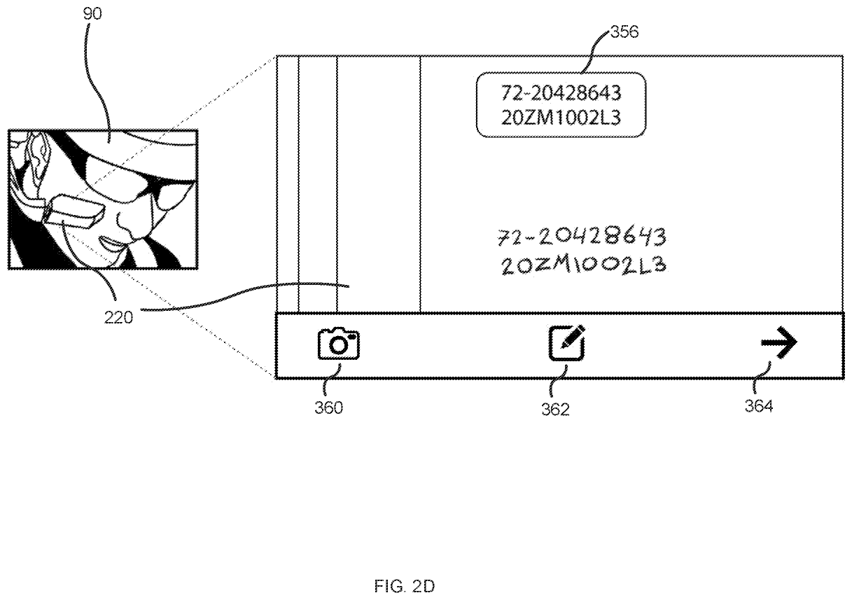

For example, mobile or other QA capture device(s) 202 can include any special- and/or general-purpose handheld, tablet, desktop, or other device(s) 204 and/or headset device(s) or system(s) 206 configured to capture images of parts or components of mechanical, electrical, or other assemblies (including subassemblies) of manufactured items, or any portion(s) thereof; and to accept input by means of any suitably-configured physical and/or virtual keyboards, including for example touchscreen devices, voice-recognition systems, etc., from QA, manufacturing, or other personnel 90; to edit, save, create, output, display, communicate, or otherwise process data collected through such means; and wireless and/or other communications systems adapted to route or otherwise communicate such data to any one or more of processor(s) and/or memory(ies) 102, 106, 104, 108. As shown in FIGS. 2a-2c, such devices 202 can for example include any one or more display screens 220 (including touchscreens); physical or virtual keyboards or switches 222; cameras, bar or QR code readers, or other capture devices 224; processors or controllers 226; memory(ies) 228; GPSs and/or other motion, position, thermal, electrical, and/or orientation sensors 230; microphones 232; speakers 234; and wireless or wireline communication systems 236. Suitably configured smart phones, tablet computers, and/or headsets will serve, as will purpose built handheld or headset devices. In some embodiments, particularly those adapted for capturing multiple images of components 302, e.g., to confirm that they have been correctly assembled from multiple parts or subassemblies 304, 306, QA capture devices or systems 202 can comprise multiple mounted image capture systems 224, placed for example in desired fixed or re-configurable positions relative to assembly jigs or tables, and linked and/or otherwise configured to provide signal data to desktop, mobile, or other processing devices 202, 204.

Other processors 102, 104, 106, 108, 202 can be implemented in the form of server-class and/or desktop computers; phones, laptops, tablet computers, and other PDAs, etc.

Various aspects of the invention, including various suitably-configured embodiments of systems, devices, methods, and programming products for facilitating quality control, assessment, and inspection processes relating to parts and assemblies, can be understood by reference to the figures. For example, with reference to FIG. 1A, a method for such processing can be performed through the operations of mobile and/or other component characteristic capture devices 202, 204; one or optionally more quality control servers 102, QA controllers 104, and QA data stores 106, and optionally one or more customer systems 108.

At 502, as shown for example in FIG. 2c, an operator 90 of a QA capture device 202, 204, 206 can use a camera 224 or other sensor to capture an image of or other data associated with a part and/or assembly plate 352, or other portion of a component 900, and route it to a QA data processor 102, 226 associated with the device 202. Plate 352 can for example include a permanently- or removably-affixed metal plate, label, decalcomania or other transfer, and/or printed, engraved, etched, stamped, painted or handwritten character set comprising alphanumeric and other characters or symbols, which may represent any of a very wide variety of information, including for example one or more of a manufacturer, assembler, assembly number, part number, and/or part- or assembly serial numbers. Data representing the image 354 (FIG. 2c) collected by camera 224 at 502 can be associated with network address(es) associated with the device 202 and/or the QA processor 102; an operator identification associated with the operator 90 who captured the image; and a date, time, and/or location stamp, and/or any other desired data, to generate a component identify data set for routing to QA capture device 202 at 502.

At 504 the QA data processor 102, 226 can process image data comprised by the component identity data set received at 502 to interpret one or more characters or other component characteristics represented by the image data, using for example any of a wide variety of known image analysis and character interpretation techniques such as those described below.

For example, the QA processor 102, 226 can execute machine-readable instructions stored in persistent memory accessible by the quality control data processing system, the instructions representing logical rules for automated processing of image data to interpret characters represented within the image data. Such rules can, for example, be configured to cause application by the quality control data processing system of rules associated with at least one part-numbering convention. For example, at the time of capturing captures an image of an identification plate or other part or assembly identifier 352, the user 90 can refer to an electronic assembly record to select one or more parts, components, or subassemblies and thereby cause associated detail part or assembly numbers to be incorporated into the component identity data set along with captured image data; and when the processor 102 executes character recognition, it can wholly or partly rely upon known patterns associated with all or various parts of the detail part or component numbers associated with the image—e.g., expected alphanumeric character sequences or groupings.

As will be understood by those skilled in the relevant arts, in various embodiments such image processing and data extraction or interpretation, and other functions, can be accomplished by, or in cooperation with, processors 226 associated with the QA capture device(s) 202, 204 that captured the images, through the use of suitably-configured machine-interpretable instruction sets stored on or otherwise accessible by the device(s) 202, 204, and any suitable corresponding distributed data-processing techniques.

When the processor 102, 226 has completed a process of interpreting characters and/or geometric or other data comprised or otherwise represented by the image data received at 502, at 504 the processor 102 can return to the device 202 from which the component identity data set was received (and/or any other desired devices 202, 104, 106, 108) an identifier review data set comprising data representing the one or more interpreted characters, along with any desired address and/or routing information associated with the device(s) 202, 104, 106, 108, as well as any desired portion of the image data received at 504.

Upon receipt of the identifier review data set at 504, the user 90′s device 202 can display at least the interpreted characters on a display 220, 222 (FIGS. 2b, 2c, 2d) for comparison by the user 90 with information presented on the part or assembly plate 352. The interpreted characters can, for example, be presented in an image subset 356 presented on the display 222, 220 of the device 202 as shown in FIGS. 2c and 2d. Working with the display 222, keyboard(s) 228, etc. of his/her device 202, for example through use of editing and other command icons 360, 362, 364, etc., the user 90 can correct any misinterpreted characters in the displayed data set 356 and, when satisfied that the interpreted characters adequately represent desired characters on the plate 352, can enter a confirmational command 366 or corresponding keyboard instructions using the display 222, 220, and/or keyboard(s) 228, and at 506 can cause her/his device 202 to route to the same or another identifier QA processor 102 an interpreted character confirmation data set comprising signals representing a confirmation that the identifier associated with the one or more interpreted characters is wholly or sufficiently correct.

Upon receipt at 506 of a suitable interpreted character confirmation data set, at 510 the QA processor 102 can store, in persistent memory(ies) 106 accessible by the quality control data processing 102 system a confirmed component identity data set comprising at least the component identity image data set received at 502 and/or 506, and the one or more interpreted characters associated with the interpreted character confirmation data set.

In some embodiments, displays 356 and corresponding data sets can include suggested alternate interpretations of the one or more interpreted characters, based on any of a wide variety of logical associations, including for example commonly-known errors in handwriting interpretation, known patterns in part, assembly, and/or serial number formats applied by manufacturers, assemblers, or other parties, etc. In some such embodiments such alternative interpretations can be displayed in ranked order of expected probability or likelihood, so that a user 90 can quickly navigate to and select a correct interpretation for use in a corrected identifier data set.

In some embodiments, at 508, prior to routing confirmed character interpretation data sets to storage 106, processor(s) 102, 226 can route to one or more second identification confirmation review device(s) 104, 202, etc., for use in generating suitably-configured output displays, one or more confirmed character interpretation data sets comprising signals representing confirmed characters associated with the interpreted character confirmation data set, for review by second or further sets of eyes. For example, a QA assurance controller station 104 can be provided, for use by one or more users 90 in reviewing confirmed character identification sets and any associated photographs or images, prior to storage in memory(ies) 106.

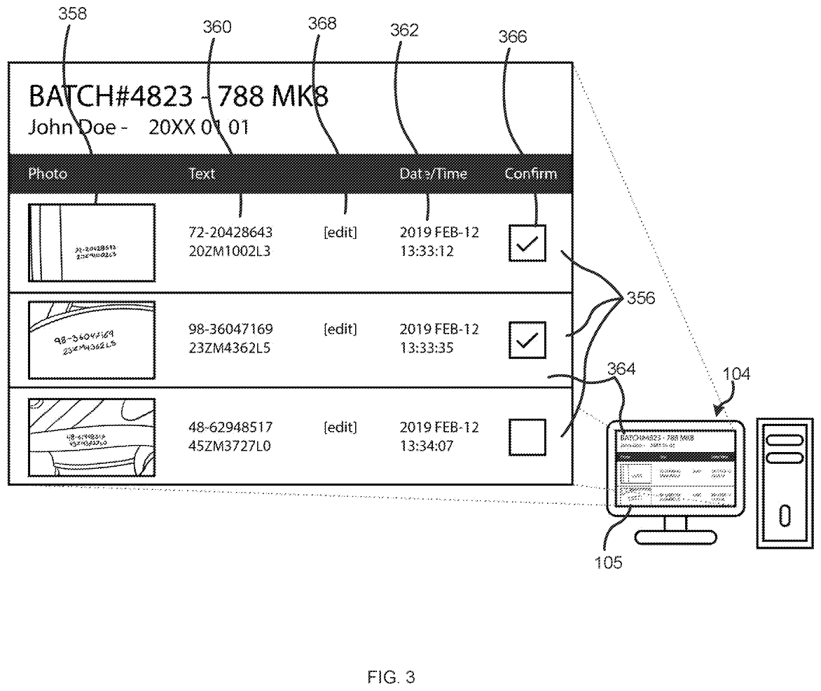

For example, as shown in FIG. 3, a station 104 can use one or more confirmed character interpretation data sets to generate an interpreted character confirmation screen 364, comprising displays of a plurality of individual interpreted character confirmation data sets 356, each comprising one or more captured part/assembly plate images 358, confirmed or proposed interpreted character data sets 360, date/time stamps 362, and edit icons 368 and confirm devices 366. A QA or other administrator 90 can review each set 356 by visually comparing characters captured in images 358 to characters 360 as interpreted by processor(s) 102, using display(s) 105. If the user 90 determines that a correction is appropriate, he/she can select the corresponding ‘edit’ command icon 368 and make appropriate correction using a keyboard 228, touchscreen 220, and/or other suitably-configured input devices, including for example drop-down or other menus of suggested alternative interpretations, as described above, which menus can be presented in ranked order of likely alternative interpretations. When the user 90 is satisfied that the interpreted characters 360 appropriately match captured characters 358, the user can enter a (second or subsequent) confirmation command by for example selecting a confirmation checkbox icon 366. Selection of a command icon 366 can cause an interpreted character confirmation data set to be generated and at 512 routed to a QA data processor 102, as shown for example in FIG. 1A. Thus in some aspects and embodiments the invention provides methods, systems, and devices configured for routing to an output display 105 of a second identification confirmation review device 104 a confirmed character interpretation data set comprising signals representing confirmed characters associated with the interpreted character confirmation data set; and for receiving from second the identification confirmation review device 104 signals representing a second confirmation that the identifier associated with the one or more interpreted characters is correct, prior to storing the confirmed component identity data set in the persistent memory 106.

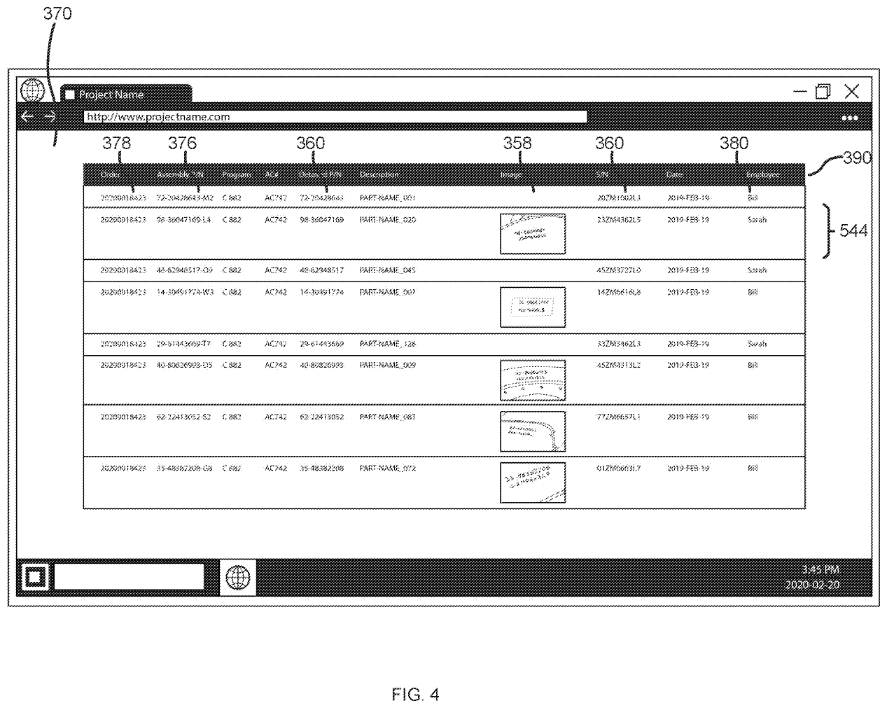

In storing confirmed component identity data sets in database(s) or other storage 106, QA processor(s) 102 can generate data sets such as the confirmed component identity set 544 displayed in FIG. 4. As may be seen in the example of FIG. 4, data set 544 can comprise confirmed part and/or serial numbers 360, character image capture data 358, and date time stamps 362 as discussed above, in addition to further data such as larger assembly or subassembly number 376, associated part or assembly order numbers 378, and line and/or QA user 90 employee identifiers 380, along with any other relevant or otherwise-desired associated information.

Such data sets can be made available for review and optionally archivable correction or updating of part and assembly records by manufacturer, assembler, QA, operator, and/or other customer personnel, at any time, before, during or after a component's operational life cycle.

As shown in FIG. 4, rows 390 associated with individual part/assemblies numbers can be displayed in different colors, such as green for data sets associated with confirmed valid data; yellow for your data sets subject to doubt, for example, where a suitable image 358 is lacking; and red for data sets known to be faulty, for example where a part or serial number 360 is known to be incorrect and further review and correction are pending. In some embodiments, as previously mentioned, errors in purportedly confirmed serial numbers can be detected automatically, by comparing reported numbers against known or required patterns; mismatches in required or otherwise expected patterns can be reported as faulty, and instructions for review and correction can be generated.

Confirmed component identity sets 544 stored in secure memory(ies) 106 can be used for any of a wide variety of purposes. For example, customers to whom completed assemblies are delivered, or by whom they might later be operated, can be authorized to access such databases for purposes of tracking the performance of individual specific parts, subassemblies, and larger assemblies, and/or any desired grouping of parts or part types; implementing preventative maintenance and upkeep schemes, replacing parts at desired points in their life cycles, etc.

In addition to recording, confirming, and archiving information such as part, serial, and assembly numbers, and dates of installation or manufacture, etc., for use in tracking, maintaining, and improving components 900 and parts 302, 304, etc., systems 100 in accordance with various aspects and embodiments of the invention can be used for a very wide variety of further QA applications and assessments, including for example verifying that the right types, numbers, and quality(ies) of parts have been used, and have been assembled in proper sequence(s) and configuration(s), according to proper procedures, and in the proper relative and/or absolute orientations, etc. By acquiring and archiving correctly-interpreted images of each part or subassembly, optionally along with associated information such as part and/or serial numbers, assembly sequences, installation specifications (e.g., torque levels, fastener specifications, materials, coatings, lubrication or finishing) or other types of instructions, during the assembly process, the precise actual and intended states of a component or assembly can be memorialized and made rapidly and efficiently available to operators, repair and/or replacement or refurbishment personnel, regulators, etc. for any desired reviews, corrections, or assessments.

An example of such a method can be described with reference to FIG. 1B. Processing can, for example, be performed through the operations of mobile, fixed, and/or other component identifier capture devices or systems 202, 204, controlling one or more fixed or re-configurable image capture devices 224; one or more quality control servers 102, QA controllers 104, and QA data stores 106, and optionally one or more customer systems 108.

At 1502, for example, as shown in FIG. 2c, an operator 90 of a QA capture device or system 202, 204, 206 can cause one or more cameras 224 to capture one or more images, including still and/or video images, of any one or more parts and/or assemblies 900, and route the image(s) to a QA data processor 102 associated with the device or system 202. Assembly(ies) 900 can comprise any number of parts, sub-assemblies, and/or other components 302, 304, and can be imaged multiple times (including continuously) during the assembly process. Thus, for example, any one or more of image capture devices 224 can be used to capture any desired numbers of images, videos, or other sensor scans of an assembly 900 and/or each of parts 302, 304, etc., at any one or more points or steps during an assembly process, from any desired angles or vantage points. For example, each time include a part or component 302, 303, is added to an assembly 900, before-and-after images can be taken; videos and/or still images of specific steps such as placement, alignment, torqueing or other fastening can be captured, electrical current sensing for crack control/structural integrity purposes, or other anomalies. Data representing any or all of such images or scan outputs 354 can be collected, in any desired number or sets by processors of device(s) 202, and can be associated with part or assembly numbers or other desired information, network address(es) associated with the device 202 and/or the QA processor 102; operator identification(s) associated with the operator 90 who captured the image(s); and date, time, and/or location stamp(s), and/or any other desired data, to generate one or more component image data sets for routing from QA capture device 202 to QA data processor(s) 102, 226 at 1502.

At 1504 the QA data processor 102, 226 can process image data comprised by the component image data set(s) received at 1502 to interpret or otherwise assess one or more characteristics of the assembly 900 represented by the image data, using for example any of a wide variety of known image or sensor analyses, including character interpretation techniques such as those described elsewhere herein. For example, in some embodiments multiple images can be used to generate 3D model, using photogrammetry techniques for example. Such 3D models can then be used for performing remote or local inspections by any desired types or numbers of inspectors.

For example, QA processor(s) 102 can execute machine-readable instructions stored in persistent memory accessible by the quality control data processing system, the instructions representing logical rules for automated processing of image or other scanned or sensed data to interpret geometrical, positional, thermal, alphanumerical, and/or other characteristics or symbols represented within the image data. Such rules can, for example, be configured to cause application by the quality control data processing system of rules associated with at least one part-numbering convention. For example, at the time of capturing images or other sensor data, the user 90 and/or QA operator device/system 202 can refer to an electronic assembly record to select one or more parts, components, or subassemblies and thereby cause associated detail part or assembly identifiers to be incorporated into or otherwise associated with the component image data set along with captured image data; and when the processor 102 executes image recognition processes, it can wholly or partly rely upon known or expected geometric, thermal, and/or alphanumeric, or other patterns associated with all or various parts 302, 304 of the detail part or component numbers associated with the image—e.g., expected orientations, relative positionings, alphanumeric character sequences, markings, colors, temperatures, etc. to compare captured image characteristics to required or otherwise expected characteristics in order, for example, to ensure that assemblies have been properly built up, etc.

Among characteristics trackable in accordance with various embodiments are: (1) whether a correct part is present, based for example on interpreted part or serial numbers; (2) whether such part(s) are installed correctly, with respect for example to relative position, orientation, sequence, etc.; (3) whether the component(s) are correct in the context of whole or other larger assemblies, for example whether various parts are installed in proper combinations, sequences, and/or orientations for Left vs. Right landing gear, etc.

In the same and other embodiments, automatic detection of predefined and/or other problems can be implemented. For example, systems 1000 can apply machine learning techniques to detect whether parts is installed correctly; and/or images can be used to give an individual (90) information required make such judgements. That such information can, for example, include series of images in the database, reference images, overlays, and corresponding 2-D or 3-D models,

For example, digital or other forms of “twin” geometries can be compared to images or other sensed data sets to detect anamolies, using two-, three-, four- or other dimensional analyses or assessments to assess assembly states, compliance with assembly requirements, etc.

Alternatively, in various embodiments such image processing and data/characteristic extraction, interpretation, and/or other assessment functions can be accomplished by, or in cooperation with, processors 226 the QA capture device(s) 202, 204 that captured the images, through the use of suitably-configured machine-interpretable instruction sets stored on or otherwise accessible by the device(s) 202, 204, and any suitable corresponding distributed data-processing techniques.

As will be appreciated by those skilled in the relevant arts, once they have been made familiar with this disclosure, each of alphanumeric and/or other characters or symbols, part and/or assembly geometry(ies), and other properties, can be considered characteristics, along with features such as geometry, temperature, electrical state, orientation, etc.

When the processor 102 (and/or device 202) has completed its process of interpreting characteristics represented by the image data received at 1502, at 1504 the processor 102 can return to the device 202 from which the component identity data set was received (and/or any other desired devices 202, 104, 106, 108) a characteristic review data set comprising data representing the one or more interpreted characteristics, such as overlaid or side-by-side comparative images of expected and captured geometries, thermal patterns, etc. along with any desired address and/or routing information associated with the device(s) 202, 104, 106, 108, as well as any desired portion of the image data received at 1504.

Upon receipt of the characteristic review data set at 1504, the user 90′s device 202 can display at least the representations of the interpretations or other assessments provide by processor(s) 102/226 on a display 220, 222 (FIGS. 2b, 2c, 2d) for comparison by the same or another user 90 with information useful for comparing the characteristics with required or otherwise expected standards, as for example comparative images as described above, text- and/or image-based instructions, information, etc. The assessed characteristics can, for example, be presented in an image subset 356 presented on a display 222, 220 of a device 202 as shown in FIGS. 2c and 2d. Working with the assembly 900 and display 222, keyboard(s) 228, etc. of his/her device 202, for example through use of editing and other command icons 360, 362, 364, etc. as well as any physical tools, the user 90 can make any desired or required corrections to the assembly 900 and/or associated characteristic data sets, and, when satisfied that the interpreted characteristics adequately correspond to desired characteristics, at 1506 can enter a confirmational command 366 or corresponding keyboard instructions using the display 222, 220, and/or keyboard(s) 228, and cause her/his device 202 to route to the same or another identifier QA processor 102 an interpreted characteristic confirmation data set comprising signals representing a confirmation that the identifier associated with the one or more interpreted characters is wholly or sufficiently correct.

Upon receipt at 1506 of a suitable interpreted character confirmation data set, at 1510 the QA processor 102 (and or processor(s) 202) can store, in persistent memory(ies) 106 accessible by the quality control data processing 102 system, a confirmed component identity data set comprising at least the component identity image data set received at 502 and/or 506, and the one or more interpreted characters associated with the interpreted character confirmation data set.

In some embodiments, displays 356 and corresponding data sets can include suggested alternate interpretations, configurations, or orientations of the one or more interpreted characteristics, based on any of a wide variety of logical associations, including for example commonly-known errors in assembly, known patterns in part, assembly, and/or serial number geometries applied by manufacturers, assemblers, or other parties, etc. In some such embodiments such alternative interpretations can be displayed in ranked order of expected probability or likelihood, so that a user 90 can quickly navigate to, select, and physically implement a correct interpretation, and perform any necessary re-imaging.

In some embodiments, at 1508, at any time confirmed characteristic interpretation data sets can routed to one or more second characteristic review device(s) 104, 202, etc., for use in generating suitably-configured output displays, one or more confirmed characteristic assessment data sets comprising signals representing confirmed characteristics associated with the interpreted characteristic data set, for review by second or further sets of eyes. For example, a QA assurance controller station 104 can be provided, for use by one or more users 90 in reviewing confirmed character identification sets and any associated photographs or images, prior to storage in memory(ies) 106. Alternatively, any corrected, updated, or otherwise modified characteristic data sets can be stored in association with earlier data sets, so that historical logs or records can be kept indefinitely, for later reference.

For example, a station 104 can use one or more confirmed characteristic assessment (or interpretation) data sets to generate an interpreted characteristic confirmation screen 364, comprising displays of a plurality of individual interpreted characteristic confirmation data sets 356, each comprising captured character or other characteristic images 358, any associated informational data sets 360, which can for example include representations of any desired installation or assembly references, as well as confirmed text of any interpreted characters, date/time stamps 362, and edit icons 368 and confirm devices 366. A QA or other administrator 90 can review each set 356 by visually comparing geometries or other characteristics captured in images 358 to expected characteristics 360 as interpreted by or otherwise accessed and presented by processor(s) 102, using display(s) 105. If the user 90 determines that a correction is appropriate, he/she can select the corresponding ‘edit’ command icon 368 and generate appropriate corrections and/or correctional instructions using a keyboard 228, touchscreen 220, and/or other suitably-configured input devices, including for example drop-down or other menus of suggested alternative interpretations and/or configurations, as described above, which menus can be presented in ranked order of likely alternative interpretations. When the user 90 is satisfied that the interpreted characters 360 appropriately match captured characters 358, and/or that an assembly is properly configured, the user can enter a (second or subsequent) confirmation command by for example selecting a confirmation checkbox icon 366. Selection of a command icon 366 can cause an interpreted character confirmation data set to be generated and at 512 routed to a QA data processor 102, as shown for example in FIG. 1A.

In storing confirmed component image or assessment data sets in database(s) or other storage 106, QA processor(s) 102 can generate data sets such as the confirmed component identity or assessment set 544 displayed in FIG. 4. As may be seen in the example of FIG. 4, data set 544 can comprise confirmed part and/or serial numbers 360, image capture data 358, and date/time stamps 362 as discussed above, in addition to further data such as larger assembly or subassembly number 376, associated part or assembly order numbers 378, and line and/or QA user 90 employee identifiers 380, along with any other relevant or otherwise-desired associated information.

As shown in FIG. 4, rows 390 of interpretation or assessment data associated with individual part/assemblies numbers can be displayed in different colors, such as green for data sets associated with assemblies assessed as being properly configured; yellow for your data sets subject to doubt, for example, where a suitable image 358 is lacking; and red for data sets known to represent faulty configurations, for example where a part 302, 304 has been improperly installed, and further review and correction are pending.

Confirmed component identity sets 544 stored in secure memory(ies) 106 can be used for any of a wide variety of purposes. For example, customers to whom completed assemblies are delivered, or by whom they might later be operated, can be authorized to access such databases for purposes of tracking the proper configuration of specific parts and/or assemblies, and their performance; for implementing preventative maintenance and upkeep schemes, replacing parts at desired points in their life cycles, etc.

In further aspects and embodiments, the invention provides methods for facilitating quality control and inspection of parts and assemblies, such methods performed by a handheld quality control operator data processing system 202, 204, 206, etc., and comprising receiving from at least one input device 224, 228, 220 of the handheld processing system 202 signals representing a designation of a component type identifier; receiving from an image capture device of the handheld processing system data representing an image of at least a portion of a component associated with the designated component type identifier; routing to a quality control data processing server 102, via a network communication system 236 of the handheld data processing system, a component analysis (or ‘assessment’ or ‘interpretation’) data set comprising data representing at least the designated component type identifier and the data representing an image associated with the designated component type identifier; receiving from the same or another quality control processing server 102 component characteristic review data set comprising data representing one or more interpreted characteristics represented by or otherwise associated with the captured image; receiving from the same or another input device 220, 228, 224 of the handheld processing system signals representing at least one of a confirmation or correction of at least one of the interpreted characters received from the quality control processing server, and routing to the same or another quality control processing server 102 a confirmed characteristic data set associated with the component associated with the designated component type identifier. As with other embodiments of the invention, in some embodiments of this aspect of the invention some or all of the image/characteristic assessment processing performed in this process, and in the examples described below, can be performed by processor(s) 226 on board the operator control device 202, 204, etc.

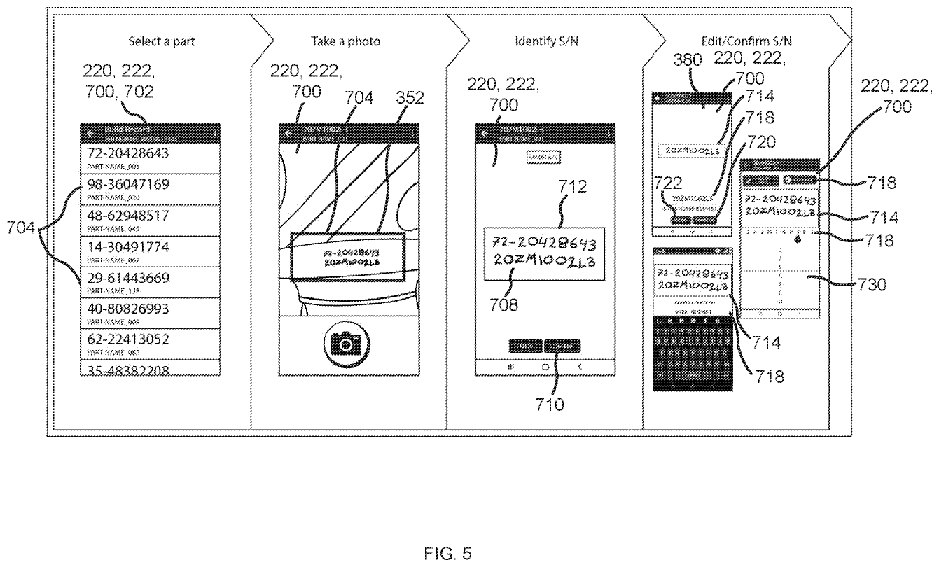

An embodiment of such a process is illustrated through reference to FIG. 5, in which user interfaces 700 of a capture device 202 are generated by displays 220 222 of the device 202. In step 1002, an assembly worker or other user 90 has invoked and logged into an application executed wholly or partially by the user's device 202, optionally in processing combination with one or more QA servers 102; and has pulled up a new assembly build record 702 for a job 801201907, which consists of a listing of a plurality of parts, comprising individual records 704 corresponding to parts and subassemblies to be used in building up a nose landing gear assembly for an aircraft.

The user 90 can select a part such as a buildup subassembly 520Z1110-505, and at 1004 can scan or capture all or relevant portions 704 of a corresponding assembly identification plate 352, or other portion of a component or assembly 900, using a digital camera, bar code or QR code reader, or other capture device 224 of the handheld device 202. In some embodiments, the user 90 can simply point an image capture device 224 of his controller 202 at the part or assembly 900, and the part can automatically be recognized and identified using image recognition techniques, as previously described.

When the user 90 is satisfied with framing of his or her capture region 704, at 502 (see FIG. 1A) the user can simultaneously capture the image can cause his/her device 202 to capture the image and generate a component characteristic data set comprising data representing at least those portion(s) of the image comprising the identifier(s) or other characteristic(s) to be interpreted, or otherwise assessed, by the QA processor 102, and to route the component identity data set to the processor 102 via communications system 236 (FIG. 2b). In some embodiments, framing of regions to be captured can be accomplished automatically by one or more processors 226 of image capture devices 224, as shown for example in FIGS. 1B and 2C.

In some embodiments, as shown for example at 1006, prior to routing a component characteristic data set to the QA processor 102 at 502, processor(s) 226 can parse the image data captured by the user, and present to the user 90 an interface 708 comprising editable windows 712 which can be adjusted by the user 90 (using for example a touchscreen device 220, 222) to confirm that image regions comprising characters for which interpretation is desired have been correctly defined; and data defining such windows can be included in the component identity set routed to the processor(s) 102. Once the user is satisfied with his/her adjustments, invocation of a ‘confirm’ command 710 can cause the component identity data set to be routed to the processor 102, 226, as shown for example at 502 in FIG. 1A.

At 1008, 504 the user's device 202 can receive from QA processor(s) 102, 226 an interpreted characteristic set, and display it on the user's device 220, 222.

For example, as shown at 1008a, the user can be presented with a representation 714 of at least a portion of the image captured at 1004, 1006, and a display 716 of captured characteristic(s) as interpreted by the processor 102. If the user 90 is able to confirm that the interpreted characteristic(s) properly correspond with those of the captured image, or to applicable assembly requirements, etc., then the user can select a corresponding command icon 720, and thus cause his device 202 to generate an interpreted characteristic confirmation data set comprising signals representing a confirmation that the identifier associated with the one or more interpreted characters is correct, and at 506 to route the confirmation to the responsible QA processor(s) 102, 226. Thus the user's device 202 can in some embodiments be referred to as a identifier review device 202. Similarly, if at 508 (FIG. 1A) the same or another interpreted character set is routed to a QA controller 104, 202 for a ‘second set of eyes’ review, the controller 104, 202 can also be referred to as a identifier review device.

If the user 90 is not satisfied with processor 102, 226′s assessment of the characteristics, the user can select a command icon such as that shown at 722 in order to cause a characteristic correction application interface to be generated and displayed, such as either of the examples shown at 1008b and 1008c, so that the user 90 can enter any appropriate corrections.

In the example shown at 1008b, the interpreted or otherwise assessed characteristic data set 718 is displayed in an active input field with a virtual or physical keyboard 228, which the user can use to enter any corrections prior to routing a confirmed data set to the processor 102.

In the example shown in 1008c, the interpreted or otherwise assessed data characteristic set 718 is provided together with one or more listings 730 of suggested alternative characters, for selection by the user 90 to correct any individual characters. Such listings 730 can be generated wholly or party by either or both of processor(s) 102, 226.

When a user 90 has edited an assessment proposed by the processor 102, the user can select a command icon 710 to confirm the edited character set and route to the same or another processor 102 an edited image data set.

In further aspects, the invention provides QA capture devices 202, 204, 206 for users 90 such as assemblers, such assemblers' devices for capture of serial and/or part numbers, assembly or other component images, etc., and comprising one or more releasable mounts, such as ‘pistol’ type grips, glasses, or other types of headsets, comprising an optical image capture component 224 such as a digital camera and/or one or more bar code and/or QR code readers 24; input/output devices 220, 222, 228; memory(ies) 236 for at least temporarily storing captured/corrected data; and one or more processors 226 configured to enable an operator 90 to load a build/assembly record 702, select one or more part or assembly identifiers 704, such as part number(s) or name(s); capture images 352 of at least a serial or part number, or other component characteristic; route captured data sets (can include part/assembly data as well as image data) to characteristic interpretation or assessment systems (e.g. local or enterprise servers) 102; receive from the processor 102 processed image data comprising interpreted or otherwise assessed characteristic set(s) 718 (and optionally image with boundary boxes 712) through use of one or more character, shape, color, temperature, electrical state, or other recognition logical instruction sets and/or editor information; receive operator input confirming or correcting interpreted characteristic(s); route confirmation/corrected data sets to the interpretation/assessment system 102 and/or one or more QA stations 104 (for second set of eyes). Optionally, such devices can automatically delete all captured, received, and/or corrected data from onboard memory, or at least desired subsets thereof, in order for example to improve data security.

While the disclosure has been provided and illustrated in connection with specific, presently-preferred embodiments, many variations and modifications may be made without departing from the spirit and scope of the invention(s) disclosed herein. For example, as will be appreciated by those skilled in the relevant arts and disclosed above, data processing can be accomplished in any desired centralized or distributed manner(s), such that for example the application of logical rules for interpreting characters, part and assembly configurations, etc., can be accomplished as a centralized server function by one or more QA servers 102 as shown in FIG. 1A and described above, and/or such processing can be partly or wholly performed by other processor(s) of system(s) 100, including for example QA capture device(s) 202 and processor(s) 226, controller station(s) 104, etc. Alternatively, any or all of components 102, 104, 106, 108, 202, 224, 226 can be combined into one or more multi-purpose devices, and/or they can be implemented as separate, communicatively-linked devices as shown for example in FIGS. 1A and 1B.

The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A method of quality control, assessment, and inspection of parts and assemblies, the method performed by a quality control data processing system and comprising:
receiving, from a component image capture device, a component image data set comprising data representing at least an image of a portion of a component of a manufactured assembly;
processing the received component image data set to interpret or otherwise assess at least one characteristic of the component represented by the image data;
routing to an output display of at least one image assessment review device a characteristic review data set comprising data representing the one or more interpreted characteristics;
receiving from the same or another identifier review device an interpreted characteristic confirmation data set comprising signals representing a confirmation that one or more characterizations associated with the one or more interpreted characteristics is correct; and
storing in persistent memory accessible by the quality control data processing system a confirmed component characteristic data set comprising at least data representing an identity of the component and data representing the confirmed characteristic.

2. The method of claim 1, wherein the component image capture device comprises a digital camera.

3. The method of claim 1, comprising a plurality of component image capture devices.

4. The method of claim 1, wherein at least one interpreted characteristic of the component comprises a part number.

5. The method of claim 1, wherein at least one interpreted characteristic of the component comprises a serial number.

6. The method of claim 1, wherein at least one interpreted characteristic of the component comprises a component configuration.

7. The method of claim 1, wherein processing the received component identity data set to interpret one or more characteristics represented by the image data comprises execution by the quality control data processing system of machine-readable instructions stored in persistent memory accessible by the quality control data processing system, the instructions representing logical rules for automated processing of image data to interpret characters represented within the image data.

8. The method of claim 7, wherein the logical rules are configured to cause application by the quality control data processing system of rules associated with at least one part numbering convention.

9. The method of claim 1, the identifier review data set comprising data representing at least one suggested alternate interpretation of the one or more interpreted characteristics.

10. The method of claim 9, wherein a plurality of alternate interpretations are displayed by the identifier review device in accordance with ranked likelihoods of correct alternative interpretations.

11. The method of claim 1, comprising:
routing to an output display of a second identification confirmation review device the same or another confirmed component characteristic data set, comprising signals representing one more or confirmed characteristics associated with the interpreted characteristic confirmation data set: and
receiving from second the identification confirmation review device signals representing a second confirmation that one or more characterizations associated with the one or more interpreted characteristics is correct, prior to storing the confirmed component identity data set in the persistent memory.

12. A method for facilitating quality control, assessment, and inspection of parts and assemblies, the method performed by a quality control operator data processing system and comprising:
receiving from at least one input device of the operator processing system signals representing a designation of a component type identifier;
receiving from at least one image capture device of the operator processing system data representing an image of at least a portion of a component associated with the designated component type identifier;
routing to a quality control data processing server, via a network communication system of the handheld data processing system, a component assessment data set comprising data representing at least the designated component type identifier, at least one assessed characteristic of the component, and the data representing an image associated with the designated component type identifier;
receiving from the same or another quality control processing server an identifier review data set comprising data representing one or more assessed characteristics associated with the captured image;
receiving from the same or another input device of the operator processing system signals representing a correction of at least one of the assessed characteristics received from the quality control processing server; and
routing to the same or another quality control processing server a confirmed assessed characteristic data set associated with the component associated with the designated component type identifier.

13. The method for facilitating quality control and inspection of parts and assemblies of claim 12, comprising:
receiving from the same or another input device of the handheld processing system signals representing a command for editing of an image captured by the at least one image capture device; and
routing to the same or another quality control processing server an edited image data set.
